(19) United States
(12) Patent Application Publication
(10) Pub. No.: US 2025/0105670 A1
(43) Pub. Date: Mar. 27, 2025

(54) WIRELESS POWER TRANSFER SYSTEM, AND TRANSMITTER AND RECEIVER THEREFOR

(71) Applicant: Solace Power Inc., Mount Pearl (CA)

(72) Inventor: Samer ALDHAHER, London (GB)

(73) Assignee: Solace Power Inc., Mount Pearl (CA)

(21) Appl. No.: 18/891,690

(22) Filed: Sep. 20, 2024

Related U.S. Application Data
(60) Provisional application No. 63/539,974, filed on Sep. 22, 2023.

(51) Int. Cl. H02J 50/12; H02M 1/00; H02M 3/335

(52) U.S. Cl. CPC H02J 50/12; H02M 1/0058; H02M 3/33571

(57) ABSTRACT

A transmitter for transferring power to a receiver of a wireless power transfer system is provided. The transmitter comprises a transmitter element and an inverter comprising a switched mode zero-voltage switching (ZVS) amplifier. The amplifier comprises a pair of circuits. The circuits comprise at least a transistor and at least a capacitor arranged in parallel. The circuits further comprise at least an inductor arranged in series with the transistor and capacitor. The amplifier further comprises a ZVS inductor electrically connected to the pair of circuits. The ZVS inductor operates as the transmitter element of the transmitter to transfer power to a receiver of a wireless power transfer system via magnetic field coupling. The transmitter may alternatively comprise a transmitter element, and an combined direct current/direct current (DC/DC) converter and inverter. The combined DC/DC converter and inverter comprises an amplifier comprising: a pair of circuits. The circuits comprise at least a transistor and at least a capacitor arranged in parallel, and at least an inductor arranged in series with the transistor and capacitor. The combined DC/DC converter and inverter comprises a half-bridge and the inductors of the pair of circuits. The inductors are electrically connected to the half-bridge. The inductors are adapted to store and release energy for DC/DC conversion, and the inductors are adapted to operate as a choke for the inverter. Other aspects are also provided.

### CROSS REFERENCE TO RELATED APPLICATIONS

This application claims the benefit of U.S. Provisional Application No. 63/539,974 filed on Sep. 22, 2023, the entire contents of which is incorporated herein by reference.

### FIELD

The subject disclosure relates generally to wireless power transfer, and in particular to a wireless power transfer system, and transmitter and receiver for the same.

### BACKGROUND

Wireless power transfer systems such as wireless charging are becoming an increasingly important technology to enable the next generation of devices. The potential benefits and advantages offered by the technology is evident by the increasing number of manufacturers and companies investing in the technology.

A variety of wireless power transfer systems are known. A typical wireless power transfer system includes a power source electrically connected to a wireless power transmitter, and a wireless power receiver electrically connected to a load.

In magnetic induction systems, the transmitter has a transmitter coil with a certain inductance that transfers electrical energy from the power source to the receiver, which has a receiver coil with a certain inductance. Power transfer occurs due to coupling of magnetic fields between the coils or inductors of the transmitter and receiver. Such induction system may non-resonant or resonant. In resonant magnetic induction the inductors are resonated using capacitors. The range of power transfer in resonant magnetic systems may be increased over that of magnetic induction systems and alignment issues may be rectified.

In electrical induction systems, the transmitter and receiver have capacitive electrodes. Power transfer occurs due to coupling of electric fields between the capacitive electrodes of the transmitter and receiver. Similar, to resonant magnetic systems, there exist resonant electric systems in which the capacitive electrodes of the transmitter and receiver are made resonant using inductors, e.g., coils. Resonant electric systems may have an increased range of power transfer compared to that of electric induction systems and alignment issues may be rectified.

While some wireless power transfer systems are known, improvements are desired. It is therefore an object to provide a cooling arrangement for a wireless power transfer system, wireless power transfer system and/or method of cooling a receiver.

This background serves only to set a scene to allow a person skilled in the art to better appreciate the following description. Therefore, none of the above discussion should necessarily be taken as an acknowledgement that the discussion is part of the state of the art or is common general knowledge. One or more aspects/embodiments of the invention may or may not address one or more of the background issues.

### SUMMARY

According to an aspect there is provided a transmitter for transferring power to a receiver of a wireless power transfer system, the transmitter comprising a transmitter element and an inverter comprising a switched mode zero-voltage switching (ZVS) amplifier comprising:
a pair of circuits comprising:
   at least a transistor and at least a capacitor arranged in parallel; and
   at least an inductor arranged in series with the transistor and capacitor;
a ZVS inductor electrically connected to the pair of circuits, the ZVS inductor operating as the transmitter element of the transmitter to transfer power to a receiver of a wireless power transfer system via magnetic field coupling.

As the ZVS operates as both the inductor in the inverter and the transmitter element thereby eliminating the need for an additional coil to operate as the transmitter element, losses from normally lossy coils/inductors may be reduced. Accordingly, power transfer efficiency of the transmitter may be improved compared to conventional transmitter.

The ZVS inductor may comprise a plurality of windings. The plurality of windings may form a coil. The coil may have an air-core.

The transmitter may comprise an combined direct current/direct current (DC/DC) converter and inverter. The combined DC/DC converter and inverter may provide the functionality of both a DC/DC converter and inverter while using fewer components that two separate circuits adapted to perform both tasks. The combined DC/DC converter and inverter may comprise one or more inductors. The inductors may be choke inductors. The choke inductors may function to provide dual DC conversion and inversion. The choke inductors operate as energy storage components adapted to convert an input DC voltage applied to the inverter to a lower value (to provide the DC/DC conversion), and to regulate and control the generated AC output current (to provide the inverter functionality). By having a single combined DC converter and inverter which provides both DC/DC conversion and inversion of the DC signal to AC, the size and weight of the transmitter may be reduced. Additionally, reducing the number of inductors required, since multiple inductors are not required in both the DC/DC converter and inverter, improved power transfer efficiency as inductors are generally lossy electrical components.

The inverter may comprise an combined direct current/direct current (DC/DC) converter and inverter for converting an input DC signal to the inverter to a desired level and inverting a DC signal to alternating current (AC), the DC/DC converter electrically connected to the inverter.

The combined DC/DC converter and inverter may receive a power signal from a power source. The power source may be a DC source. The combined DC/DC converter and inverter may convert the power signal having one voltage level to another signal having a different voltage level to be input to the transmitter.

The combined DC/DC converter and inverter may comprise a half-bridge and the inductors of the pair of circuits, the inductors electrically connected to the half-bridge.

As such the inductors provide a function for both DC/DC conversion and the inverter. In other words, the inductors have a dual functionality. This avoids additional components in the DC/DC converter that may impact efficiency, size, and weight. In particular, extra inductors and chokes are avoided. As these components are large and cause power loss, the transmitter has reduced weight and size, and improved power transfer efficiency when compared with conventional transmitter in power transfer systems.

In such an arrangement, the combined DC/DC converter and inverter is not separable blocks/circuits as the described inductors provide a functionality for both DC/DC conversion and DC/AC inversion. Conventional DC/DC converters and inverters are typically separate blocks/circuits which results in a larger and heavier transmitter. Additionally, power transfer efficiency may be reduced when compared with the described non-separable DC/DC converter and inverter.

The half-bridge or H-bridge may comprise a high-side switch/transistor and a low-side switch/transistor for synchronous operation, or a switch/transistor and a diode for non-synchronous operation.

The half-bridge may comprise a transistor and a diode electrically connected to the transistor in parallel. The half-bridge may comprise a high-side switch/transistor and a low-side switch/transistor for synchronous operation, or a switch/transistor and a diode for non-synchronous operation.

The half-bridge may have a first switching frequency, and the transistors of the pair of circuits may have a second switching frequency.

The second switching frequency may be larger than the first switching frequency. For example, the second switching frequency may be approximately 80 kHz-10 MHz. The first switching frequency may be 20-200 kHz. One of skill in the art will appreciate these values are exemplary and other frequencies may be used. For example, the first switching frequency may be 50 kHz and the second frequency may be 1 MHz.

The inductors may be adapted to store and release energy for DC/DC conversion, and the inductors may be adapted to operate as a choke for the inverter.

The inductors may be adapted to provide a constant DC current.

The combined DC/DC converter and inverter may be a class E inverter.

The combined DC/DC converter and inverter may be load-independent.

According to another aspect there is provided a transmitter for transferring power to a receiver of a wireless power transfer system, the transmitter comprising a transmitter element, and a combined DC/DC converter and inverter,
the combined DC/DC converter and inverter comprising:
   a pair of circuits comprising:
      at least a transistor and at least a capacitor arranged in parallel; and
      at least an inductor arranged in series with the transistor and capacitor, and
   a half-bridge and the inductors of the pair of circuits, the inductors electrically connected to the half-bridge,
wherein the inductors are adapted to store and release energy for DC/DC conversion, and the inductors are adapted to operate as a choke for the inverter.

The inductors provide a function for both DC/DC conversion and the inverter. In other words, the inductors have a dual functionality. This avoids additional components in the DC/DC converter that may impact efficiency, size, and weight. In particular, extra inductors and chokes are avoided. As these components are large and cause power loss, the transmitter has reduced weight and size, and improved power transfer efficiency when compared with conventional transmitter in power transfer systems.

In other words, the combined inverter and DC/DC converter form a non-separable circuit, i.e., the circuits components of the DC/DC converter cannot be separated from the inverter, and similarly the circuits components of the inverter cannot be separated from the DC/DC converter and still provide their respective functionalities.

The half-bridge may comprise a transistor and a diode electrically connected to the transistor in parallel. The half-bridge may comprise a high-side switch/transistor and a low-side switch/transistor for synchronous operation, or a switch/transistor and a diode for non-synchronous operation.

The inductors may be adapted to provide a constant DC current.

The combined DC/DC converter and inverter may be a class E inverter.

The combined DC/DC converter and inverter may be load-independent.

The half-bridge may have a first switching frequency, and the transistor of the pair of the circuits has a second switching frequency.

The second switching frequency may be larger than the first switching frequency. For example, the second switching frequency may be approximately 80 kHz-10 MHz. The first switching frequency may be 20-200 kHz. One of skill in the art will appreciate these values are exemplary and other frequencies may be used. For example, the first switching frequency may be 50 kHz and the second frequency may be 1 MHz.

According to another aspect there is provided an inverter operating with direct current/direct current (DC/DC) conversion functionality for a transmitter of a wireless power transfer system,
the inverter comprising:
   a pair of circuits comprising:
      at least a transistor and at least a capacitor arranged in parallel; and
      at least an inductor arranged in series with the transistor and capacitor, and
a half-bridge and the inductors of the pair of circuits of the inverter, the inductors electrically connected to the half-bridge,
wherein the inductors are adapted to store and release energy for DC/DC conversion, and the inductors are adapted to operate as a choke for the inverter.

The inductors provide a function for both DC/DC conversion and the inverter. In other words, the inductors have a dual functionality. This avoids additional components in the DC/DC converter that may impact efficiency, size, and weight. In particular, extra inductors and chokes are avoided. As these components are large and cause power loss, the transmitter has reduced weight and size, and improved power transfer efficiency when compared with conventional transmitter in power transfer systems.

In other words, the combined DC/DC converter and inverter forms a non-separable circuit, i.e., the circuits components of the DC/DC converter cannot be separated from the inverter, and similarly the circuits components of the inverter cannot be separated from the DC/DC converter and still provide their respective functionalities.

The half-bridge may comprise a transistor and a diode electrically connected to the transistor in parallel. The half-bridge may comprise a high-side switch/transistor and a low-side switch/transistor for synchronous operation, or a switch/transistor and a diode for non-synchronous operation.

The inductors may be adapted to provide a constant DC current.

The combined DC/DC converter and inverter may be a class E inverter.

The combined DC/DC converter and inverter may be load-independent.

The half-bridge may have a first switching frequency, and the transistor of the pair of circuits has a second switching frequency.

The second switching frequency may be larger than the first switching frequency. For example, the second switching frequency may be approximately 80 kHz-10 MHz. The first switching frequency may be 20-200 kHz. One of skill in the art will appreciate these values are exemplary and other frequencies may be used. For example, the first switching frequency may be 50 kHz and the second frequency may be 1 MHz.

According to another aspect there is provided a method of transferring power from a transmitter to a receiver of a wireless power transfer system, the transmitter comprising a transmitter element and an inverter comprising a switched mode zero-voltage switching (ZVS) amplifier comprising:
a pair of circuits comprising:
   at least a transistor and at least a capacitor arranged in parallel; and
   at least an inductor arranged in series with the transistor and capacitor; and
a ZVS inductor electrically connected to the pair of circuits, the ZVS inductor operating as the transmitter element of the transmitter to transfer power to a receiver of a wireless power transfer system via magnetic field coupling, the method comprising:
generating a field via the transmitter element to transfer power to a receiver element of a receiver of a wireless power transfer system.

The field may be a magnetic field.

The receiver element may comprise a coil having a plurality of windings. The receiver element may be similar or identical to the transmitter element.

The transmitter may comprise at least one capacitor. The transmitter element and capacitor may be resonant when generating a magnetic field. Such resonance may improve power transfer freedom and/or efficiency between the transmitter and receiver.

Power may be transferred from the transmitter to the receiver via magnetic field coupling between the transmitter and receiver elements.

According to another aspect there is provided a method of transferring power from a transmitter to a receiver of a wireless power transfer system, the transmitter comprising a transmitter element, and an combined direct current/direct current (DC/DC) converter and inverter,
the combined DC/DC converter and inverter comprising:
   a pair of circuits comprising:
      at least a transistor and at least a capacitor arranged in parallel; and
      at least an inductor arranged in series with the transistor and capacitor, and
   a half-bridge and the inductors of the pair of circuits of the inverter, the inductors electrically connected to the half-bridge,
wherein the inductors are adapted to store and release energy for DC/DC conversion, and the inductors are adapted to operate as a choke for the inverter, the method comprising:
generating a field via the transmitter element to transfer power to a receiver element of a receiver of a wireless power transfer system.

The combined inverter and DC/DC converter form a non-separable circuit, i.e., the circuits components of the DC/DC converter cannot be separated from the inverter, and similarly the circuits components of the inverter cannot be separated from the DC/DC converter and still provide their respective functionalities.

The field may be a magnetic field.

The receiver element may comprise a coil having a plurality of windings. The receiver element may be similar or identical to the transmitter element.

The transmitter may comprise at least one capacitor. The transmitter element and capacitor may be resonant when generating a magnetic field. Such resonance may improve power transfer freedom and/or efficiency between the transmitter and receiver.

Power may be transferred from the transmitter to the receiver via magnetic field coupling between the transmitter and receiver elements.

The described methods have provide any of the benefits described in respect of the transmitter. Additionally, the transmitter in the described methods may have any of the additional features described with respect to the transmitters.

According to another aspect there is provided a rectifier for rectifying an alternating current (AC) signal to a direct current (DC) signal, the rectifier adapted for use in a receiver of a wireless power transfer system, the rectifier comprising a capacitor for converting a voltage signal at the receiver element to a current signal,
the capacitor electrically connected in parallel to a receiver element of a receiver of a wireless power transfer system.

The voltage signal may be induced at the receiver element via magnetic field coupling with a transmitter element of a transmitter of a wireless power transfer system. The voltage signal may be constant.

The current signal may be constant.

The rectifier may comprise an impedance transformation circuit comprising the capacitor.

The impedance transformation circuit may have a T-network topology.

A capacitance of the capacitor may be given by the following equation:

$$C 3 = \frac{1}{{αω}^{2} ( LRX 2 + LRX 3 )}$$

where C3 is the capacitance of the capacitor,
where α is a dimensionless factor such that 1.25<α≤3,
where ω is an operating frequency of the receiver,
where LRX2 is a portion of an inductance of the receiver element, and
wherein LRX3 is another portion of the inductance of the receiver element.

The value of a may allow for control of a reflected impedance of the receiver such the reflected impedance may be made more inductive or capacitive depending on the value of a load at the receiver.

The inductance of the receiver element may be given by the following equation:

$$LRX = LRX 1 + LRX 2 + LRX 3$$

where LRX is the inductance of the receiver element.

The rectifier may comprise:
a pair of circuits comprising:
   at least a diode and at least a capacitor arranged in parallel; and
   at least an inductor arranged in series with the transistor and capacitor; and
the capacitor electrically connected to the pair of circuits and to the receiver element.

The rectifier may be a Class E rectifier.

The rectifier may be a push-pull rectifier.

According to another aspect there is provided a receiver for extracting power from a field generated by a transmitter of a wireless power transfer system, the receiver comprising a receiver element electrically connected to a rectifier, the rectifier comprising a capacitor for converting a voltage signal at the receiver element to a current signal,
the capacitor electrically connected in parallel to the receiver element.

The rectifier may comprise a full-wave rectifier.

The voltage signal may be induced at the receiver element via magnetic field coupling with a transmitter element of a transmitter of a wireless power transfer system. The voltage signal may be constant.

The current signal may be constant.

The receiver may comprise an impedance transformation circuit comprising the capacitor.

The impedance transformation circuit may have a T-network topology.

A capacitance of the capacitor may be given by the following equation:

$$C 3 = \frac{1}{{αω}^{2} ( LRX 2 + LRX 3 )}$$

where C3 is the capacitance of the capacitor,
where α is a dimensionless factor such that 1.25<α≤3,
where ω is an operating frequency of the receiver,
where LRX2 is a portion of an inductance of the receiver element, and
wherein LRX3 is another portion of the inductance of the receiver element.

The value of a may allow for control of a reflected impedance of the receiver such the reflected impedance may be made more inductive or capacitive depending on the value of a load at the receiver.

The inductance of the receiver element may be given by the following equation:

$$LRX = LRX 1 + LRX 2 + LRX 3$$

where LRX is the inductance of the receiver element.

The rectifier may comprise:
a pair of circuits comprising:
   at least a diode and at least a capacitor arranged in parallel; and
   at least an inductor arranged in series with the transistor and capacitor; and
the capacitor electrically connected to the pair of circuits and to the receiver element.

The rectifier may be a Class E rectifier.

The rectifier may be a push-pull rectifier.

According to another aspect there is provided a method of transferring power from a transmitter to a receiver of a wireless power transfer system, the comprising a receiver element electrically connected to a rectifier, the rectifier comprising a capacitor for converting a voltage signal at the receiver element to a current signal,
the capacitor electrically connected in parallel to the receiver element, the method comprising:
extracting power via the receiver element from a field generated by a transmitter element of a transmitter of a wireless power transfer system.

The rectifier may comprise a full-wave rectifier.

The voltage signal may be induced at the receiver element via magnetic field coupling with a transmitter element of a transmitter of a wireless power transfer system. The voltage signal may be constant.

The receiver may further comprise a capacitor. The capacitor and receiver element may be resonant when extracting power from the field generated by the transmitter element. The power may be extracted via magnetic field coupling between the transmitter and receiver element.

According to another aspect there is provided a wireless power transfer system comprising a transmitter and receiver,
the transmitter for transferring power to the receiver, the transmitter comprising a transmitter element and an inverter comprising a switched mode zero-voltage switching (ZVS) amplifier comprising:
   a pair of circuits comprising:
      at least a transistor and at least a capacitor arranged in parallel; and
   at least an inductor arranged in series with the transistor and capacitor;
a ZVS inductor electrically connected to the pair of circuits, the ZVS inductor operating as the transmitter element of the transmitter to transfer power to a receiver of a wireless power transfer system via magnetic field coupling; and
the receiver for extracting power from a field generated by the transmitter, the receiver comprising a receiver element electrically connected to a rectifier, the rectifier comprising a capacitor for converting a voltage signal at the receiver element to a current signal,
the capacitor electrically connected in parallel to the receiver element.

According to another aspect there is provided a wireless power transfer system comprising a transmitter and receiver,
the transmitter for transferring power to the receiver, the transmitter comprising a transmitter element, an inverter and a direct current/direct current (DC/DC) converter,
the inverter comprising:
   a pair of circuits comprising:
      at least a transistor and at least a capacitor arranged in parallel; and
      at least an inductor arranged in series with the transistor and capacitor, and
the DC/DC converter comprising a half-bridge and the inductors of the pair of circuits of the inverter, the inductors electrically connected to the half-bridge,
wherein the inductors are adapted to store and release energy for DC/DC conversion, and the inductors are adapted to operate as a choke for the inverter; and
the receiver for extracting power from a field generated by the transmitter, the receiver comprising a receiver element electrically connected to a rectifier, the rectifier comprising a capacitor for converting a voltage signal at the receiver element to a current signal,
the capacitor electrically connected in parallel to the receiver element.

The inverter and DC/DC converter form a non-separable circuit, i.e., the circuits components of the DC/DC converter cannot be separated from the inverter, and similarly the circuits components of the inverter cannot be separated from the DC/DC converter and still provide their respective functionalities.

The rectifier may comprise a full-wave rectifier.

The voltage signal may be induced at the receiver element via magnetic field coupling with a transmitter element of a transmitter of a wireless power transfer system. The voltage signal may be constant.

The described systems may have any of the benefits and/or features described in respect of the transmitter, receiver, rectifier and/or methods.

The half-bridge may comprise a transistor and a diode electrically connected to the transistor in parallel. The half-bridge may comprise a high-side switch/transistor and a low-side switch/transistor for synchronous operation, or a switch/transistor and a diode for non-synchronous operation.

The inductors may be adapted to provide a constant DC current to the inverter.

The inverter may be a class E inverter.

The inverter may be load-independent.

The half-bridge may have a first switching frequency, and the inverter may have a second switching frequency.

The second switching frequency may be larger than the first switching frequency. For example, the second switching frequency may be approximately 80 kHz-10 MHz. The first switching frequency may be 20-200 kHz. One of skill in the art will appreciate these values are exemplary and other frequencies may be used. For example, the first switching frequency may be 50 kHz and the second frequency may be 1 MHz.

The voltage signal may be constant. In other words, the signal may have a constant voltage level.

The current signal may be constant. In other words, the signal may have a constant current level.

The receiver may comprise an impedance transformation circuit comprising the capacitor.

The impedance transformation circuit may have a T-network topology.

A capacitance of the capacitor may be given by the following equation:

$$C 3 = \frac{1}{{αω}^{2} ( LRX 2 + LRX 3 )}$$

where C3 is the capacitance of the capacitor,
where α is a dimensionless factor such that 1.25<α≤3,
where ω is an operating frequency of the receiver,
where LRX2 is a portion of an inductance of the receiver element, and
wherein LRX3 is another portion of the inductance of the receiver element.

The value of a may allow for control of a reflected impedance of the receiver such the reflected impedance may be made more inductive or capacitive depending on the value of a load at the receiver.

The inductance of the receiver element may be given by the following equation:

$$LRX = LRX 1 + LRX 2 + LRX 3$$

where LRX is the inductance of the receiver element.

The rectifier may comprise:
a pair of circuits comprising:
   at least a diode and at least a capacitor arranged in parallel; and
   at least an inductor arranged in series with the transistor and capacitor; and
the capacitor electrically connected to the pair of circuits and to the receiver element.

The rectifier may be a Class E rectifier.

The rectifier may be a push-pull rectifier.

According to another aspect there is provided a wireless power transfer system comprising:
the described transmitter; and
the described receiver.

The transmitter may be adapted to transfer power to the receiver via magnetic field coupling.

According to another aspect there is provided a transmitter for transferring power to a receiver of a wireless power transfer system, the transmitter comprising a transmitter element comprising an air-core coil having a plurality of overlaying flat windings, the transmitter element surrounding a shaft of an electric motor.

The windings may surround the shaft of an electric motor. Each winding may generally be in a different radial plane than an adjacent winding. The windings may be parallel in the axial plane.

The transmitter may further comprise:
a transmitter field cancellation element. The field cancellation element may be adapted to reduce current loss in a shaft of an electric motor which the transmitter element, i.e., the windings, surrounds.

At least one of the transmitter element and the transmitter field cancellation element may surround a shaft of an electric motor.

The electric motor may be a current-excited synchronous motor.

The transmitter field cancellation element and transmitter element may be co-planar in a radial direction relative to the shaft. In other words, the cancellation and transmitter elements may be in the same radial plane.

The transmitter field cancellation element may comprise a magnetic field cancellation coil having a plurality of overlaying flat windings. The windings may be in the opposite direction to those of the transmitter element. In this way losses from current induced in the shaft of the motor may be prevented due to the opposite windings of the cancellation element.

The cancellation element may comprise copper and/or aluminium wrapped around the rotor shaft adjacent the transmitter element. Such wrapped material may reduce eddy current losses in the shaft.

The transmitter may further comprise:
an inverter comprising a switched mode zero-voltage switching (ZVS) amplifier comprising:
   a pair of circuits comprising:
      at least a transistor and at least a capacitor arranged in parallel; and
      at least an inductor arranged in series with the transistor and capacitor;
   a ZVS inductor electrically connected to the pair of circuits, the ZVS inductor operating as the transmitter element of the transmitter to transfer power to a receiver of a wireless power transfer system via magnetic field coupling.

The transmitter may comprise an combined direct current/direct current (DC/DC) converter and inverter. The combined DC/DC converter and inverter may provide the functionality of both a DC/DC converter and inverter while using fewer components that two separate circuits adapted to perform both tasks. The combined DC/DC converter and inverter may comprise one or more inductors. The inductors may be choke inductors. The choke inductors may function to provide dual DC conversion and inversion. The choke inductors operate as energy storage components adapted to convert an input DC voltage applied to the inverter to a lower value (to provide the DC/DC conversion), and to regulate and control the generated AC output current (to provide the inverter functionality). By having a single combined DC converter and inverter which provides both DC/DC conversion and inversion of the DC signal to AC, the size and weight of the transmitter may be reduced. Additionally, reducing the number of inductors required, since multiple inductors are not required in both the DC/DC converter and inverter, improved power transfer efficiency as inductors are generally lossy electrical components.

The transmitter may further comprise:
a direct current/direct current (DC/DC) converter for converting an input signal to the inverter to a desired level, the DC/DC converter electrically connected to the inverter.

The DC/DC converter may comprise a half-bridge and the inductors of the pair of circuits of the inverter, the inductors electrically connected to the half-bridge.

The half-bridge may comprise a transistor and a diode electrically connected to the transistor in parallel. The half-bridge may comprise a high-side switch/transistor and a low-side switch/transistor for synchronous operation, or a switch/transistor and a diode for non-synchronous operation.

The half-bridge may have a first switching frequency, and the inverter may have a second switching frequency.

The second switching frequency may be larger than the first switching frequency. For example, the second switching frequency may be approximately 80 kHz-10 MHz. The first switching frequency may be 20-200 kHz. One of skill in the art will appreciate these values are exemplary and other frequencies may be used. For example, the first switching frequency may be 50 kHz and the second frequency may be 1 MHz.

The inductors may be adapted to store and release energy for DC/DC conversion, and the inductors may be adapted to operate as a choke for the inverter.

The inductors may be adapted to provide a constant DC current to the inverter.

The inverter may be a class E inverter.

The inverter may be load-independent.

The transmitter may further comprise:
an inverter and a direct current/direct current (DC/DC) converter,
the inverter comprising:
   a pair of circuits comprising:
      at least a transistor and at least a capacitor arranged in parallel; and
      at least an inductor arranged in series with the transistor and capacitor, and
the DC/DC converter comprising a half-bridge and the inductors of the pair of circuits of the inverter, the inductors electrically connected to the half-bridge,
wherein the inductors are adapted to store and release energy for DC/DC conversion, and the inductors are adapted to operate as a choke for the inverter.

The inverter and DC/DC converter form a non-separable circuit, i.e., the circuits components of the DC/DC converter cannot be separated from the inverter, and similarly the circuits components of the inverter cannot be separated from the DC/DC converter and still provide their respective functionalities.

The half-bridge may comprise a transistor and a diode electrically connected to the transistor in parallel. The half-bridge may comprise a high-side switch/transistor and a low-side switch/transistor for synchronous operation, or a switch/transistor and a diode for non-synchronous operation.

The inductors may be adapted to provide a constant DC current to the inverter.

The inverter may be a class E inverter.

The inverter may be load-independent.

The half-bridge may have a first switching frequency, and the inverter may have a second switching frequency.

The second switching frequency may be larger than the first switching frequency. For example, the second switching frequency may be approximately 80 kHz-10 MHz. The first switching frequency may be 20-200 kHz. One of skill in the art will appreciate these values are exemplary and other frequencies may be used. For example, the first switching frequency may be 50 kHz and the second frequency may be 1 MHz.

According to another aspect there is provided a receiver for extracting power from a field generated by a transmitter of a wireless power transfer system, the receiver comprising a receiver element comprising an air-core coil having a plurality of overlaying flat windings, the receiver element surrounding a shaft of an electric motor.

The windings may surround the shaft of an electric motor. Each winding may generally be in a different radial plane than an adjacent winding. The windings may be parallel in the axial plane.

The receiver may further comprise
a receiver field cancellation element. The field cancellation element may be adapted to reduce current loss in a shaft of an electric motor which the receiver element, i.e., the windings, surrounds.

At least one of the receiver element and the receiver field cancellation element may surround a shaft of an electric motor.

The electric motor may be a current-excited synchronous motor.

The receiver field cancellation element and the receiver element may be co-planar in a radial direction relative to the shaft. In other words, the cancellation and receiver elements may be in the same radial plane.

The receiver field cancellation element may comprise a magnetic field cancellation coil having a plurality of overlaying flat windings. The windings may be in the opposite direction to those of the receiver element. In this way losses from current induced in the shaft of the motor may be prevented due to the opposite windings of the cancellation element.

The cancellation element may comprise copper and/or aluminium wrapped around the rotor shaft adjacent the transmitter element. Such wrapped material may reduce eddy current losses in the shaft.

The receiver element may be electrically connected to a rectifier, the rectifier comprising a capacitor for converting a voltage signal at the receiver element to a current signal,
the capacitor electrically connected in parallel to the receiver element.

The rectifier may comprise a full-wave rectifier.

The voltage signal may be induced at the receiver element via magnetic field coupling with a transmitter element of a transmitter of a wireless power transfer system. The voltage signal may be constant.

The current signal may be constant.

The receiver may comprise an impedance transformation circuit comprising the capacitor.

The impedance transformation circuit may have a T-network topology.

A capacitance of the capacitor may be given by the following equation:

$$C 3 = \frac{1}{{αω}^{2} ( LRX 2 + LRX 3 )}$$

where C3 is the capacitance of the capacitor,
where α is a dimensionless factor such that 1.25<α≤3,
where ω is an operating frequency of the receiver,
where LRX2 is a portion of an inductance of the receiver element, and
wherein LRX3 is another portion of the inductance of the receiver element.

The value of α may allow for control of a reflected impedance of the receiver such the reflected impedance may be made more inductive or capacitive depending on the value of a load at the receiver.

The inductance of the receiver element may be given by the following equation:

$$LRX = LRX 1 + LRX 2 + LRX 3$$

where LRX is the inductance of the receiver element.

The rectifier may comprise:
a pair of circuits comprising:
   at least a diode and at least a capacitor arranged in parallel; and
   at least an inductor arranged in series with the transistor and capacitor; and
the capacitor electrically connected to the pair of circuits and to the receiver element.

The rectifier may be a Class E rectifier.

The rectifier may be a push-pull rectifier.

According to another aspect there is provided a wireless power transfer system comprising:
a transmitter comprising a transmitter element comprising an air-core coil having a plurality of overlaying flat windings; and
a receiver comprising a receiver element for extracting power from a field generated by the transmitter, the receiver element comprising an air-core coil having a plurality of overlaying flat windings.

The transmitter and receiver elements may surround a shaft of an electric motor. The transmitter element and the receiver element may be in the same radial plane relative to the shaft. The coil of the transmitter element may have a first radius. The coil of the receiver element may have a second radius. The first radius may be greater than or smaller than the second radius. The coil of the transmitter element may form an inner coil with the coil of the receiver element forming an outer coil. Alternatively, the coil of the transmitter element may form an outer coil with the coil of the receiver element forming an inner coil. Both the inner and outer coils may surround the shaft.

The system may further comprise:
one or more shielding elements. The shielding elements may be adapted to confine a field generated by the transmitter, specifically a field generated by the air-core coil of the transmitter. The shielding may be adapted to prevent unwanted environmental effects of the field generated by the transmitter.

The shielding elements may comprise a cylindrical shielding element. The shielding elements may comprise a first shielding plate and a second shielding plate. The cylinder shielding elements and plates may enclose the air-core coils of the transmitter and receiver. The cylindrical shielding element and plates may form an enclosure enclosing the cores of the transmitter and receiver.

The coil of the transmitter may surround the coil of the receiver.

The coils may be in the same radial plane centred by a shaft. The coils may surround the shaft.

The coil of the transmitter may have a first radius and the coil of the receiver may have a second radius. The first radius may be smaller than the second radius.

The transmitter may further comprise:
a transmitter field cancellation element. The field cancellation element may be adapted to reduce current loss in a shaft of an electric motor which the transmitter element, i.e., the windings, surrounds.

At least one of the transmitter element and the transmitter field cancellation element may surround a shaft of an electric motor.

The electric motor may be a current-excited synchronous motor.

The transmitter field cancellation element and transmitter element may be co-planar in a radial direction relative to the shaft. In other words, the cancellation and transmitter elements may be in the same radial plane.

The transmitter field cancellation element may comprise a magnetic field cancellation coil having a plurality of overlaying flat windings. The windings may be in the opposite direction to those of the transmitter element. In this way losses from current induced in the shaft of the motor may be prevented due to the opposite windings of the cancellation element.

The cancellation element may comprise copper and/or aluminium wrapped around the rotor shaft adjacent the transmitter element. Such wrapped material may reduce eddy current losses in the shaft.

The receiver may further comprise:
a receiver field cancellation element. The field cancellation element may be adapted to reduce current loss in a shaft of an electric motor which the receiver element, i.e., the windings, surrounds.

At least one of the receiver element and the receiver field cancellation element may surround a shaft of an electric motor.

The electric motor may be a current-excited synchronous motor.

The receiver field cancellation element and the receiver element may be co-planar in a radial direction relative to the shaft. In other words, the cancellation and receiver elements may be in the same radial plane.

The receiver field cancellation element may comprise a magnetic field cancellation coil having a plurality of overlaying flat windings. The windings may be in the opposite direction to those of the receiver element. In this way losses from current induced in the shaft of the motor may be prevented due to the opposite windings of the cancellation element.

The cancellation element may comprise copper and/or aluminium wrapped around the rotor shaft adjacent the transmitter element. Such wrapped material may reduce eddy current losses in the shaft.

The transmitter may further comprise a power source.

The power source may be a direct current (DC) power source.

The receiver may further comprise a load.

The load may comprise a rotor winding of an electric motor.

The electric motor may be a current-excited synchronous motor.

The transmitter may further comprise:
an inverter comprising a switched mode zero-voltage switching (ZVS) amplifier comprising:
   a pair of circuits comprising:
      at least a transistor and at least a capacitor arranged in parallel; and
      at least an inductor arranged in series with the transistor and capacitor;
   a ZVS inductor electrically connected to the pair of circuits, the ZVS inductor operating as the transmitter element of the transmitter to transfer power to a receiver of a wireless power transfer system via magnetic field coupling.

The transmitter may comprise a combined direct current/direct current (DC/DC) converter and inverter. The combined DC/DC converter and inverter may provide the functionality of both a DC/DC converter and inverter while using fewer components that two separate circuits adapted to perform both tasks. The combined DC/DC converter and inverter may comprise one or more inductors. The inductors may be choke inductors. The choke inductors may function to provide dual DC conversion and inversion. The choke inductors operate as energy storage components adapted to convert an input DC voltage applied to the inverter to a lower value (to provide the DC/DC conversion), and to regulate and control the generated AC output current (to provide the inverter functionality). By having a single combined DC converter and inverter which provides both DC/DC conversion and inversion of the DC signal to AC, the size and weight of the transmitter may be reduced. Additionally, reducing the number of inductors required, since multiple inductors are not required in both the DC/DC converter and inverter, improved power transfer efficiency as inductors are generally lossy electrical components.

The transmitter may further comprise:
a direct current/direct current (DC/DC) converter for converting an input signal to the inverter to a desired level, the DC/DC converter electrically connected to the inverter.

The DC/DC converter may comprise a half-bridge and the inductors of the pair of circuits of the inverter, the inductors electrically connected to the half-bridge.

The half-bridge may comprise a transistor and a diode electrically connected to the transistor in parallel. The half-bridge may comprise a high-side switch/transistor and a low-side switch/transistor for synchronous operation, or a switch/transistor and a diode for non-synchronous operation.

The half-bridge may have a first switching frequency, and the inverter may have a second switching frequency.

The second switching frequency may be larger than the first switching frequency. For example, the second switching frequency may be approximately 80 kHz-10 MHz. The first switching frequency may be 20-200 kHz. One of skill in the art will appreciate these values are exemplary and other frequencies may be used. For example, the first switching frequency may be 50 kHz and the second frequency may be 1 MHz.

The inductors may be adapted to store and release energy for DC/DC conversion, and the inductors may be adapted to operate as a choke for the inverter.

The inductors may be adapted to provide a constant DC current to the inverter.

The inverter may be a class E inverter.

The inverter may be load-independent.

The transmitter may further comprise:
an inverter and a direct current/direct current (DC/DC) converter,
the inverter comprising:
   a pair of circuits comprising:
      at least a transistor and at least a capacitor arranged in parallel; and
      at least an inductor arranged in series with the transistor and capacitor, and
the DC/DC converter comprising a half-bridge and the inductors of the pair of circuits of the inverter, the inductors electrically connected to the half-bridge,
wherein the inductors are adapted to store and release energy for DC/DC conversion, and the inductors are adapted to operate as a choke for the inverter.

The inverter and DC/DC converter form a non-separable circuit, i.e., the circuits components of the DC/DC converter cannot be separated from the inverter, and similarly the circuits components of the inverter cannot be separated from the DC/DC converter and still provide their respective functionalities.

The half-bridge may comprise a transistor and a diode electrically connected to the transistor in parallel. The half-bridge may comprise a high-side switch/transistor and a low-side switch/transistor for synchronous operation, or a switch/transistor and a diode for non-synchronous operation.

The inductors may be adapted to provide a constant DC current to the inverter.

The inverter may be a class E inverter.

The inverter may be load-independent.

The half-bridge may have a first switching frequency, and the inverter may have a second switching frequency.

The second switching frequency may be larger than the first switching frequency. For example, the second switching frequency may be approximately 80 kHz-10 MHz. The first switching frequency may be 20-200 kHz. One of skill in the art will appreciate these values are exemplary and other frequencies may be used. For example, the first switching frequency may be 50 kHz and the second frequency may be 1 MHz.

The receiver element may be electrically connected to a rectifier, the rectifier comprising a capacitor for converting a voltage signal at the receiver element to a current signal,
the capacitor electrically connected in parallel to the receiver element.

The rectifier may comprise a full-wave rectifier.

The voltage signal may be induced at the receiver element via magnetic field coupling with a transmitter element of a transmitter of a wireless power transfer system. The voltage signal may be constant.

The current signal may be constant.

The receiver may comprise an impedance transformation circuit comprising the capacitor.

The impedance transformation circuit may have a T-network topology.

A capacitance of the capacitor may be given by the following equation:

$$C 3 = \frac{1}{{αω}^{2} ( LRX 2 + LRX 3 )}$$

where C3 is the capacitance of the capacitor,
where α is a dimensionless factor such that 1.25<α≤3,
where w is an operating frequency of the receiver,
where LRX2 is a portion of an inductance of the receiver element, and
wherein LRX3 is another portion of the inductance of the receiver element.

The value of a may allow for control of a reflected impedance of the receiver such the reflected impedance may be made more inductive or capacitive depending on the value of a load at the receiver.

The inductance of the receiver element may be given by the following equation:

$$LRX = LRX 1 + LRX 2 + LRX 3$$

where LRX is the inductance of the receiver element.

The rectifier may comprise:
a pair of circuits comprising:
   at least a diode and at least a capacitor arranged in parallel; and
   at least an inductor arranged in series with the transistor and capacitor; and
the capacitor electrically connected to the pair of circuits and to the receiver element.

The rectifier may be a Class E rectifier.

The rectifier may be a push-pull rectifier.

It should be understood that any features described in relation to one aspect, example or embodiment may also be used in relation to any other aspect, example or embodiment of the present disclosure. Other advantages of the present disclosure may become apparent to a person skilled in the art from the detailed description in association with the following drawings.

### BRIEF DESCRIPTION OF THE DRAWINGS

Embodiments will now be described more fully with reference to the accompanying drawings in which:

FIG. 1 is a block diagram of a wireless power transfer system;

FIG. 2 is another block diagram of a wireless power transfer system;

FIG. 3 is a schematic layout of a transmitter of a wireless power transfer system according to an aspect of the disclosure;

FIG. 4a is a graph of the current at the inverter of the transmitter of FIG. 3;

FIG. 4b is a graph of the voltage across the transistors of the transmitter of FIG. 3;

FIG. 5a is a schematic layout of a receiver of a wireless power transfer system according to an aspect of the disclosure;

FIG. 5b is a schematic layout of a wireless power transfer system comprising the transmitter of FIG. 3 and the receiver of FIG. 5a;

FIG. 6a is a schematic layout of another receiver of a wireless power transfer system according to an aspect of the disclosure;

FIG. 6b is an equivalent schematic layout of a portion of the receiver of FIG. 6a;

FIG. 7 is a schematic layout of a wireless power transfer system comprising the transmitter of FIG. 3 and the receiver of FIG. 6a;

FIG. 8 is a schematic layout of another transmitter of a wireless power transfer system according to an aspect of the disclosure;

FIG. 9 is a schematic layout of a wireless power transfer system comprising the transmitter of FIG. 8 and the receiver of FIG. 6a;

FIG. 10a is a graph of the voltage across the transistors of the transmitter of the system of FIG. 9;

FIG. 10b is a graph of the voltage across the diodes of the receiver of the system of FIG. 9;

FIG. 11 a schematic layout of another transmitter of a wireless power transfer system according to an aspect of the disclosure;

FIG. 12a is a schematic layout of another receiver of a wireless power transfer system according to an aspect of the disclosure;

FIG. 12b is a schematic layout of another receiver of a wireless power transfer system according to an aspect of the disclosure;

FIG. 13 is a block diagram of an electric motor;

FIG. 14a is a portion of a transmitter of a wireless power transfer for an electric motor in accordance with an aspect of the disclosure;

FIG. 14b is a portion of the transmitter of FIG. 14a and a receiver of wireless power transfer for an electric motor in accordance with an aspect of the disclosure; and

FIG. 15 is a portion of another wireless power transfer for an electric motor in accordance with an aspect of the disclosure.

### DETAILED DESCRIPTION

The foregoing summary, as well as the following detailed description of certain examples will be better understood when read in conjunction with the appended drawings. As used herein, an element or feature introduced in the singular and preceded by the word “a” or “an” should be understood as not necessarily excluding the plural of the elements or features. Further, references to “one example” or “one embodiment” are not intended to be interpreted as excluding the existence of additional examples or embodiments that also incorporate the described elements or features. Moreover, unless explicitly stated to the contrary, examples or embodiments “comprising” or “having” or “including” an element or feature or a plurality of elements or features having a particular property may include additional elements or features not having that property. Also, it will be appreciated that the terms “comprises”, “has”, “includes” means “including but not limited to” and the terms “comprising”, “having” and “including” have equivalent meanings. It will also be appreciated that like reference characters will be used to refer to like elements throughout the description and drawings.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, and/or designed for the purpose of performing the function. It is also within the scope of the subject application that elements, components, and/or other subject matter that is described as being adapted to perform a particular function may additionally or alternatively be described as being configured to perform that function, and vice versa. Similarly, subject matter that is described as being configured to perform a particular function may additionally or alternatively be described as being operative to perform that function.

It will be understood that when an element is referred to as being “on,” “attached” to, “connected” to, “coupled” with, “contacting,” etc., another element, it can be directly on, attached to, connected to, coupled with or contacting the other element or intervening elements may also be present.

It should be understood that use of the word “exemplary”, unless otherwise stated, means ‘by way of example’ or ‘one example’, rather than meaning a preferred or optimal design or implementation.

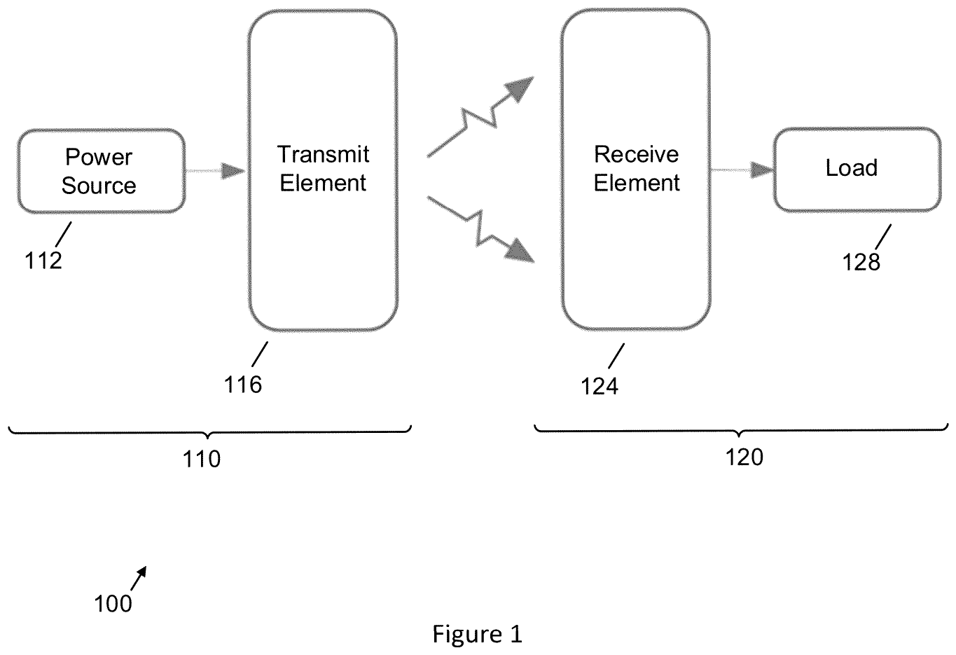

Turning now to FIG. 1, a wireless power transfer system generally identified by reference numeral 100 is shown. The wireless power transfer system 100 comprises a transmitter 110 comprising a power source 112 electrically connected to a transmitter element 116, and a receiver 120 comprising a receiver element 124 electrically connected to a load 128. Power is transferred from the power source 112 to the transmitter element 116. The power is then transferred from the transmitter element 116 to the receiver element 124 via resonant or non-resonant electric or magnetic field coupling. The power is then transferred from the receiver element 124 to the load 128. Exemplary wireless power transfer systems 100 include a high frequency inductive wireless power transfer system as described in applicant's U.S. Provisional Application No. 62/899,165, or a resonant capacitively coupled wireless power transfer system as described in applicant's U.S. Pat. No. 9,653,948B2, the relevant portions of which are incorporated herein.

In the wireless power transfer system 100, power is transferred from the transmitter element 116 to the receiver element 124. Exemplary wireless power transfer systems 100 include a high frequency inductive wireless power transfer system as described in U.S. patent application Ser. No. 17/018,328, the relevant portions of which are incorporated herein.

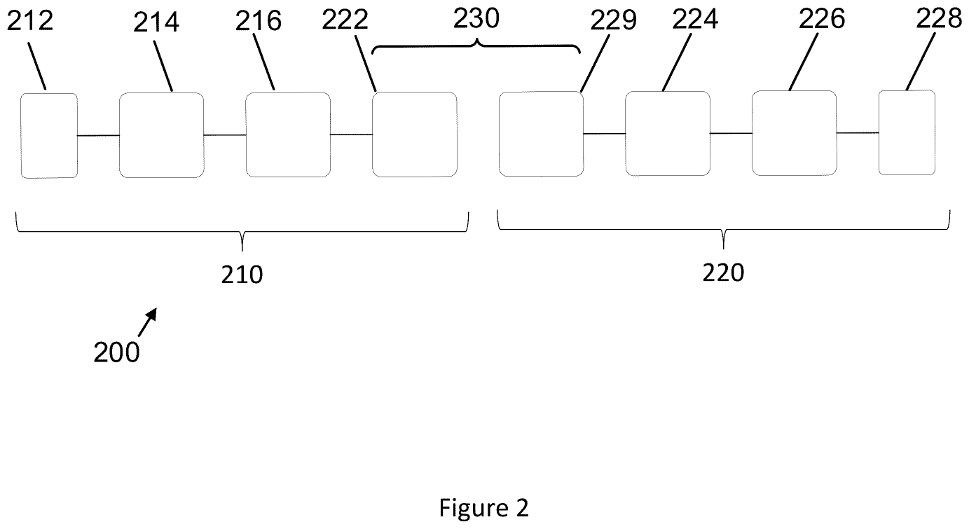

Turning now to FIG. 2, another embodiment of a wireless power transfer system is shown generally identified as reference numeral 200. The wireless power transfer system 200 comprises a power supply 212, DC/DC converter 214, circuitry 216, and transmitter element 222. The power supply 212 is electrically connected to the DC/DC converter 214. The DC/DC converter 214 is electrically connected to circuitry 216. The circuitry 216 is electrically connected to the transmitter element 222.

The power supply 212 is for generating an input power signal for transmission of power. In this embodiment, the input power signal is a direct current (DC) power signal.

The DC/DC converter 214 is for converting a received DC voltage signal to a desired voltage level. The received DC voltage may be from the power supply 212. The system 200 is illustrated as comprising the DC/DC converter 214, one of skill in the art will appreciate other configurations are possible. In another embodiment, no DC/DC converter is present.

In the illustrated arrangement, the circuitry 216 comprises an inverter and an output stage. The output stage matches the output impedance of the circuitry 216 to the optimum impedance of a wireless link 230 between the transmitter and receiver. The output stage also filters high frequency harmonic components of the inverter. As one of skill in the art will appreciate, the circuitry 216 may comprise only an inverter with no output stage being present.

The transmitter element 222 comprises one or more inductive elements, i.e., inductors. The inductive elements may comprise one or more coils. The coils may include booster or shield coils such as described in applicant's U.S. patent application Ser. No. 17/193,539, the relevant portions of which are incorporated herein by reference.

In another arrangement, the transmitter element 222 comprise one or more capacitive elements, e.g., capacitive electrodes. The capacitive electrodes may be laterally spaced, elongate electrodes; however, one of skill in the art will appreciate that other configurations are possible including, but not limited to, concentric, coplanar, circular, elliptical, disc, etc., electrodes. Other suitable electrode configurations are described in applicant's U.S. Pat. No. 9,979,206B2, the relevant portions of which are incorporated herein by reference. As one of skill in the art will appreciate, the transmitter element 222 may comprise a combination of inductive and capacitive elements.

The power source 212 supplies a DC input power signal to the DC/DC converter 214 which converts the signal to a desired voltage level. The inverter of the circuitry 216 receives the converted DC power signal and inverts the converted DC power signal to generate a magnetic and/or electric field at the transceiver element 222 to transfer power via electric or magnetic field coupling. Specifically, the transmitter element 222 generates a magnetic/electric field to transfer power to the receiver via magnetic/electric field coupling. The power source 212, DC/DC converter 214, circuitry 216 and transmitter element 222 may collectively form a transmitter 210. As previously stated, the DC/DC converter 214 may not be present in the transmitter 210.

The wireless power transfer system 200 further comprises load 228, DC/DC converter 226, circuitry 224, and receiver element 229. The load 228 is electrically connected to the DC/DC converter 226. The DC/DC converter 226 is electrically connected to circuitry 224. The circuitry 224 is electrically connected to the receiver element 229.

In the illustrated arrangement, the load 228 is a DC load. The load 228 may be static or variable.

The DC/DC converter 226 is for converting a received DC voltage signal to a desired voltage level. The received DC voltage may be from the circuitry 224. While the system 200 comprises the DC/DC converter 226, one of skill in the art will appreciate other configurations are possible. In another embodiment, no DC/DC converter 226 is present.

The circuitry 224 comprises an input stage and a rectifier, e.g., diode rectifier or synchronous rectifier. The input stage is configured to ensure optimum impedance presented to the receiver element 229 at the full power state of the wireless power transfer system 200. The input stage may also preserve the quasi-voltage source behaviour of the receiver element 229 so the output of the synchronous rectifier exhibits a stable DC voltage from no load to full load conditions. As one of skill in the art will appreciate, the circuitry 224 may comprise only a rectifier with no input stage being present.

The receiver element 229 comprises one or more inductive elements, i.e., inductors. The receiver element 229 may comprise one or more coils. The coils may include booster or shield coils such as described in applicant's U.S. patent application Ser. No. 17/193,539, the relevant portions of which are incorporated herein by reference.

In another arrangement, the transmitter element 222 comprise one or more capacitive elements, e.g., capacitive electrodes. The capacitive electrodes may be laterally spaced, elongate electrodes; however, one of skill in the art will appreciate that other configurations are possible including, but not limited to, concentric, coplanar, circular, elliptical, disc, etc., electrodes. Other suitable electrode configurations are described in applicant's U.S. Pat. No. 9,979,206B2, the relevant portions of which are incorporated herein by reference. As one of skill in the art will appreciate, the transmitter element 222 may comprise a combination of inductive and capacitive elements.

The transmitter and receiver elements 222, 229 of the system 200 form the wireless link 230. The elements 222, 229 are separated by a wireless gap. The wireless gap may be formed by atmosphere, i.e. air, or by a physical medium, e.g., walls, glass, liquids, wood, insulations, etc. Power is transferred from one element to the other across the wireless link 230 via resonant or non-resonant magnetic and/or electric field coupling, i.e., electric or magnetic induction.

During operation, the receiver element 229 extracts power from a magnetic and/or electric field generated by the transmitter element 222. The circuitry 224 acts as a rectifier, e.g., diode rectifier or synchronous rectifier, and rectifies the received power signal. The DC/DC converter 226 converts the rectified power signal to the desired power level which is received by the load 228. In this way, the receiver element 229 extracts power transmitted by the transmitter element 222 (transmitter 210) such that electrical power is transferred to the load 228 via magnetic/electric field coupling. The load 228, DC/DC converter 226, circuitry 224 and receiver element 229 may collectively form a receiver 220. As previously stated, the DC/DC converter 226 may not be present in the receiver 220.

In magnetic field coupling, the inverter (DC/AC inverter) of the circuitry 216 of the transmitter 210 is configured to convert the DC power signal from the DC/DC converter 214 into a sinusoidal RF power signal. The sinusoidal RF power signal is output from the DC/AC converter to the transmitter element 222. In the case of magnetic field coupling, the transmitter element 222 comprises a coil, i.e., a plurality of windings forming at least one coil.

The DC/AC inverter of the circuitry 216 drives the transmitter coil with a sinusoidal alternating current (AC). The transmitter coil is configured to generate an inductive (magnetic) field and to transfer power via inductive (magnetic) field coupling. The DC/AC inverter takes a DC input voltage and converts it to an AC current to drive the transmitter coil.

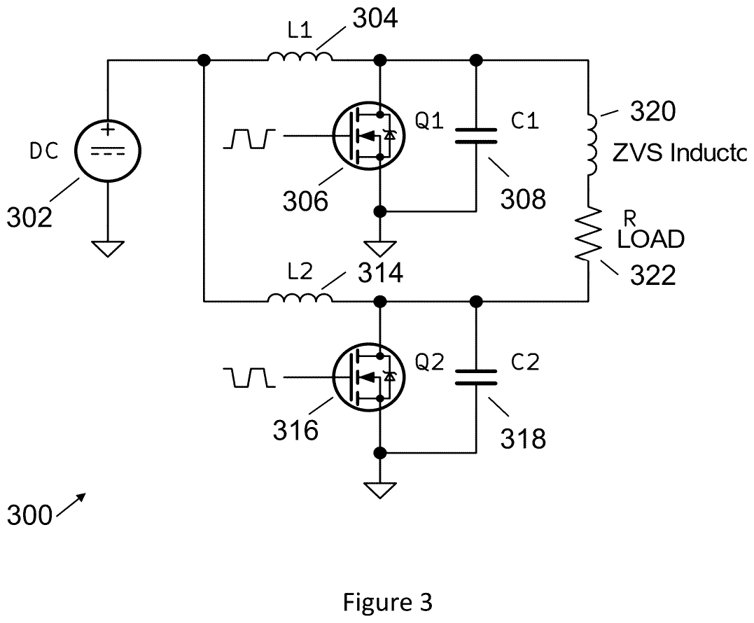

Turning now to FIG. 3, a schematic diagram of a particular arrangement of a transmitter 300, e.g., a transmitter 210 which includes circuitry 216 including a load-independent DC/AC inverter of the wireless power transfer system 200 is illustrated. In this arrangement, the transmitter 300 comprises a power source, which in this embodiment is a DC power supply 302, a DC/AC inverter and a transmitter element. The DC/AC inverter has a current-mode output. Current-mode output indicates that the DC/AC inverter has an AC output with constant amplitude and phase independent of load value.

The DC/AC inverter comprises a switched mode ZVS amplifier as will be described. The amplifier is a radio frequency (RF) amplifier. As shown in FIG. 3, the switched mode amplifier comprises series inductors 304 and 314 with inductances L1 and L2, respectively, which receive an input voltage from the power supply 302. Each inductor 304, 314 is connected in series to a combination of a transistor 306 and 316 (Q1 and Q2), respectively, (or switch) and capacitor 308 and 318. The capacitors 308 and 318 have capacitances C1 and C2, respectively. Specifically, transistor 306 and capacitor 308 are arranged in parallel, and are connected to inductor 304. Transistor 316 and capacitor 318 are arranged in parallel and are connected to inductor 314. Transistor 306 and capacitor 308 are grounded, as are transistor 316 and capacitor 318.

Inductor 320, the ZVS inductor, is connected in parallel between the inductors 304 and 314. Resistor 322 with resistance Rload is connected in series to inductor 320. Resistor 320 represents the reflected load of the receiver element, e.g., receiver coil of a receiver 220.

The inductor 320 operates as both the ZVS inductor and the transmitter element, e.g., 222 of transmitter 210, of the transmitter 300. In this way fewer components are required on the transmitter 300 allowing for the transmitter to be smaller and lighter. Additionally as additional capacitors and/or inductors are required to provide the transmitter element, as described in applicant's own US Patent Application Publication No 2021/0083634 A1, the contents of which are incorporated by reference, power transfer efficiency is improved.

In operation, the output signal from the power source 302 is DC such that the inverter is provided with DC voltage input. The current in the inductor 320 is Ac with constant amplitude. The inductors 304, 314 operate as chokes. As such, their inductances are selected such that current through them is almost DC. In one arrangement, the transistors 306, 316 are NMOS transistors. The transistors 306, 316 may be silicon, GaN, or Silicon Carbide. The transistors 306, 316 may be driven by a 50% duty cycle pulse and be 180 degrees out of phase with each other. The values of the capacitors 308, 318 and inductor 320 are selected such that load-independent operation is achieved.

As described in more detail in applicant's own US Patent Application Publication No 2021/0083634 A1, the resonant-factor (q) of the transmitter element of the transmitter 300, i.e., inductor 320, is given by equation 1 below:

$$q = \frac{1}{ω \sqrt{{L}_{ZVS} {C}_{ZVS}}} ≅ 0.985 \qquad Equation 1$$

Lzvs is the inductance of the inductor 320.
Czvs is the capacitance of the capacitors 308, 318.

The resonant-factor (q) generally indicates how close the resonant frequency of the inductor 320 (inductance LZVS) and capacitors 308, 318 (capacitance CZVS) are to the operating frequency of the transmitter 300. A resonant-factor value of 1 would indicate that the inverter's frequency is equal to the resonant frequency of inductor 320 and capacitor 308, 318 which would then imply that the inverter is a ‘resonant inverter’.

The current in the inductor 320 is given by equation 2 below:

$${I}_{COIL} = \frac{{V}_{IN}}{0.1946 \times ω {L}_{ZVS}} \qquad Equation 2$$

Vin is the input voltage, i.e., the output voltage of the power supply 302.
w is the operating frequency of the transmitter 300.

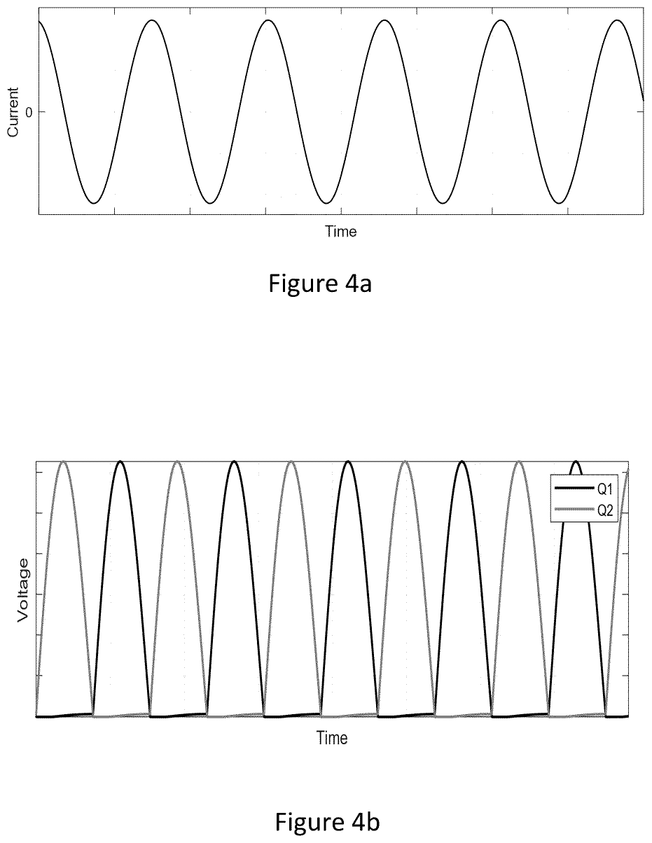

As shown in FIG. 4a, the current at the ZVS inductor 320 is alternating (AC). The voltages at transistors 306, 316 are illustrated in FIG. 4b. The voltage alternates between high and low in an opposing manner between transistors 306, 316 as the transistors 306, 316 are 180 degrees out of phase.

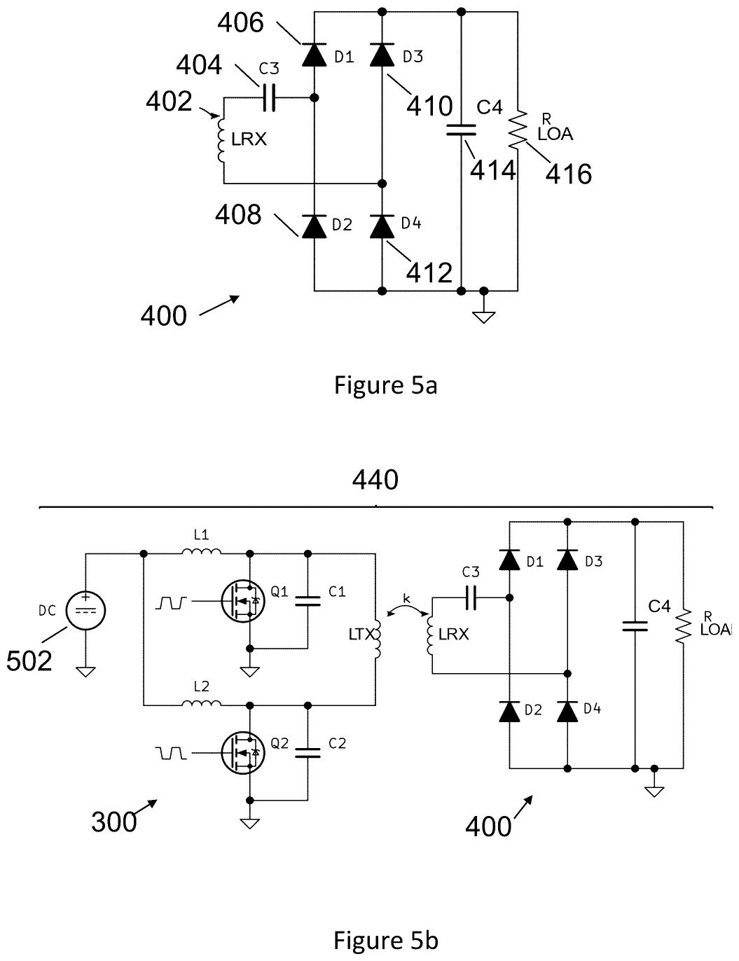

Turning now to FIG. 5a, a receiver 400 for use with the transmitter 300 is illustrated. The receiver 400 comprises a receiver element which in arrangement takes the form of inductor 402 having inductance LRX, i.e., receiver element 229 in receiver 210 of FIG. 2. The capacitor 404 operates to tune the inductor 402 for the transmitter 300.

The inductor 402 is connected in series to capacitor 404 having capacitance C3. Inductor 402 (receiver element) is connected to a full-wave rectifier comprise didoes 406, 408, 410, 412. Didoes 406, 408 are connected in series. This diode pair is connected in parallel to diodes 410, 412 which are connected in series. The full-wave rectifier is connected in parallel to capacitor 414 having capacitance C4. The capacitor 414 is a decoupling capacitor with a capacitance C4 selected such that the output voltage of the receiver 300 is DC. The capacitor 414 is connected in parallel to resistor 416 having resistance RLOAD representing the load.

As the inverter of the transmitter 300 drives the TX coil (i.e., inductor 320) with a constant current, the induced voltage at the RX coil (i.e., inductor 302) will be of constant voltage. The full-wave rectifier will provide a constant DC output voltage independent of load value.

The transmitter 300 and receiver 400 are shown together forming wireless power transfer system 440 in FIG. 5b. In operation, the transmitter 300 transfers power to the receiver 400 via magnetic coupling between inductor 320 of the transmitter 300 and inductor 402 of the receiver 400. The coupling coefficient between the transmitter 300 and receiver 400 is identified as k.

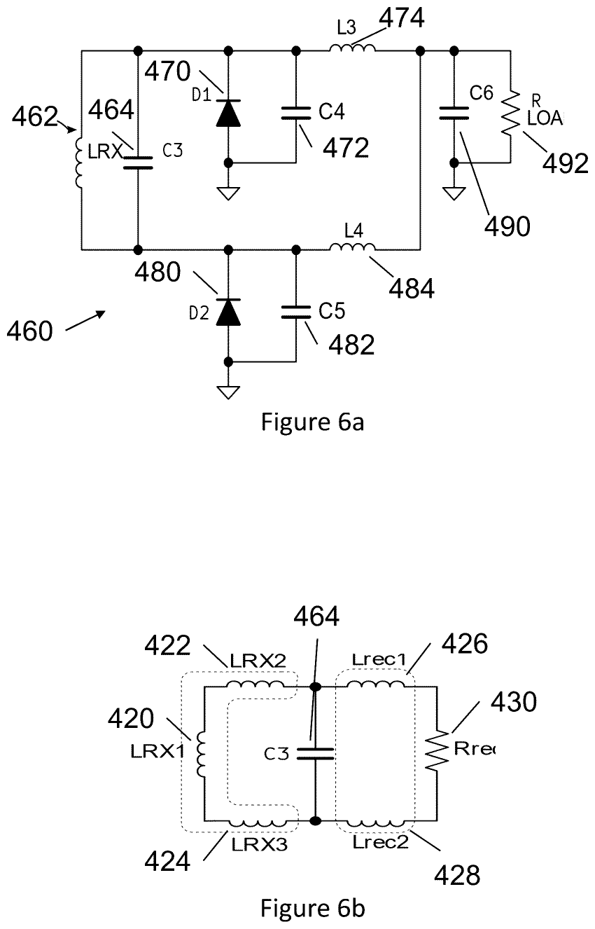

Turning now to FIG. 6a, another arrangement of the receiver is illustrated. The receiver is identified as reference numeral 460. The receiver 460 comprises inductor 462 having inductance LRX which forms the receiver element or coil, i.e., receiver element 229 of receiver 220. The inductor 462 is connected to a rectifier which is connected to the load at the receiver 460. Specifically, the inductor 462 in parallel to capacitor 464 having capacitance C3. The receiver 460 is a class E inverter in reverse. The transistors (e.g., transistors 306, 316 of transmitter 300) have been replaced with diodes 470, 480.

The capacitor 464 is connected is connected in series to a combination of the diodes 470 and 480 (D1 and D2), respectively, and capacitor 472 and 482. The capacitors 472 and 482 have capacitances C4 and C5, respectively. Specifically, diode 470 and capacitor 472 are arranged in parallel, and are connected to inductor 474 having inductance L3. Diode 480 and capacitor 482 are arranged in parallel, and are connected to inductor 484 having inductance L4. Inductors 474 and 484 are connected in parallel to capacitor 490 having capacitance C6 which is connected to resistor 492 having load RLoad representing the load of the receiver 460.

In operation, inductors 474 and 484 function as chokes. Inductance L3 and L4 are selected high enough such that the current flowing in them is DC. Capacitors 472 and 482 have similar roles to capacitors 308 and 318 in the transmitter 300. Capacitors 472 and 482 shape the voltage across the diodes 470, 480 such that rectifier at the receiver 460 operates at a 50% duty cycle (±10%).

The capacitor 464 is placed across (parallel) to the inductor 462 (receiver element/coil). Capacitor 462 is part of a T-impedance transformation circuit which its primary function is to convert the induced voltage at the inductor 462 from constant voltage to constant current. The T-impedance transformation circuit representing the rectifier is illustrated in FIG. 6b.

As shown in FIG. 6b, the rectifier is represented by its equivalent input impedance which is a series RL circuit represented by inductors 426 and 428 having inductances Lrec1 and Lrec2, respectively, and resistor 430 having resistance Rrec. The inductor 462 (receiver coil) is split into three inductors, 420, 422, 424 having inductances LRX1, LRX2, LRX3, respectively. The combination of inductors 420, 422, 424, capacitor 464 and inductors 426, 428 form a T-impedance transformation circuit.

The values of components of the rectifier are selected such that the inductance Lrec1 of inductor 426 is equal to inductance LRX2 of inductor 422, and inductance Lrec2 of inductor 428 is equal to inductance LRX3 of inductor 424.

The capacitance C3 of capacitor 464 is given by equation 3 below:

$$C 3 = \frac{1}{{αω}^{2} ( LRX 2 + LRX 3 )} \qquad Equation 3$$

w is the operating frequency of the receiver 460, and a is a dimensionless factor such that 1.25<α≤3.

The value of a allows for control of a reflected impedance of the receiver 460 such the reflected impedance may be made more inductive or capacitive depending on the value of the load 492 at the receiver 460.

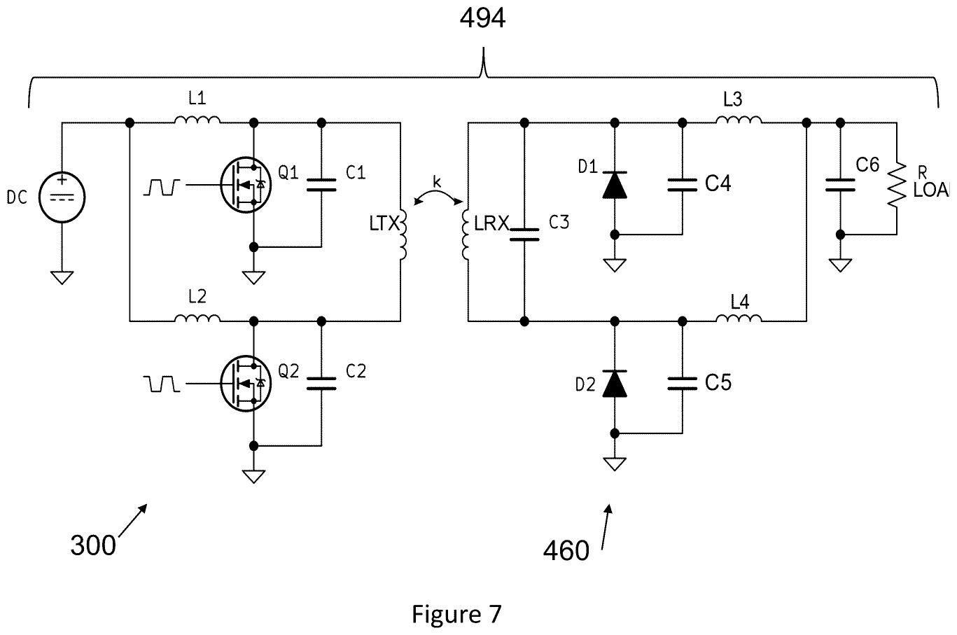

The transmitter 300 and receiver 460 are shown together forming wireless power transfer system 494 in FIG. 7. In operation, the transmitter 300 transfers power to the receiver 460 via magnetic coupling between inductor 320 of the transmitter 300 and inductor 462 of the receiver 460. The coupling coefficient between the transmitter 300 and receiver 460 is identified as k.

For a variety of applications, such as charging batteries of electric vehicles (EVs) or to power a rotor of an electric motor such as an synchronous electric motor, the output current of the transmitter must be regulated and controlled.

Current regulation is required because the load resistance may change. For example, the load resistance may change as rotor windings of an electric motor heat-up. Also the input power signal voltage may vary as it may be supplied by a battery. For example, a 400V nominal EV battery could drop down to 300V when the batteries are at their lowest charge. Consequently, the power output by the transmitter needs to controllable and adjustable.

A class E inverter, such as the inverter illustrated in connection with transmitter 300 may be difficult to control as ZVS may be lost of the frequency of operation and duty cycle of the switching cycle is adjusted. Input DC voltage to the inverter of the transmitter 300 may instead be varied by introducing a DC/DC converter to the transmitter 300. However, adding additional electrical components will increase the size and weight of the transmitter 300. Additionally, the power transfer efficiency may be reduced. In particular, adding energy storage inductors and chokes may cause power loss, and an increase in size and weight as these components are relatively large.

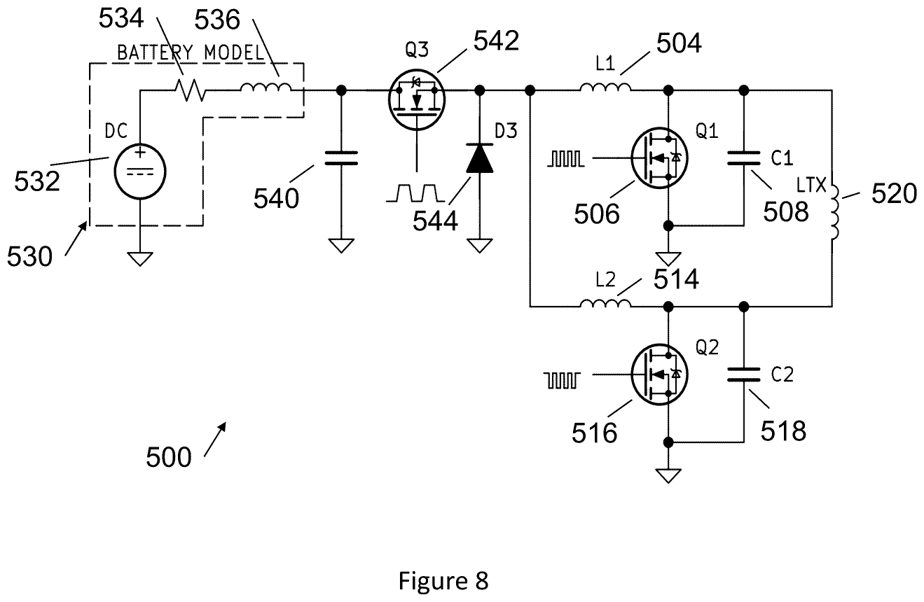

Turning now to FIG. 8 another arrangement of a transmitter 500 at least partially addressing these issues is illustrated. In this arrangement a DC/DC converter, i.e., DC/DC converter 214 has been added to the transmitter 500. A DC/DC converter is for converting a received DC voltage signal to a desired voltage level. However, instead of adding an entirely separate DC/DC conversion functionality, the inductors 504, 514 of the inverter are utilised to create the DC/DC converter. Inductors 504, 514 now have a dual purpose/functionality; first they act as the energy storage and release component that is normally present in a switched-mode DC/DC converter, and second, they act is the chokes that feed a Class E inverter with a constant DC current.

Describing the transmitter 500 in more detail, the transmitter 500 comprises a battery model 530 which comprises a power source 532 (DC power source) electrically connected in series to resistor 534 and inductor 536. The battery model 530 is connected to a half-bridge. The half-bridge comprises a capacitor 540 connected in parallel to a diode 544 (D3) with a transistor 542 (Q3) between the capacitor 540 and the diode 544.

The half-bridge is connected to the inverter similar to the inverter described in connection with transmitter 300. The inverter comprises a switched mode ZVS amplifier which is a RF amplifier. The switched mode amplifier comprises series inductors 504 and 514 with inductances L1 and L2, respectively. Each inductor 504, 514 is connected in series to a combination of a transistor 506 and 516 (Q1 and Q2), respectively, (or switch) and capacitor 508 and 518. The capacitors 508 and 518 have capacitances C1 and C2, respectively. Specifically, transistor 506 and capacitor 508 are arranged in parallel, and are connected to inductor 504. Transistor 516 and capacitor 518 are arranged in parallel and are connected to inductor 514. Transistor 506 and capacitor 508 are grounded, as are transistor 516 and capacitor 518.

Inductor 520, the ZVS inductor, is connected in parallel, along with resistor 522 having resistance R_Load, between the inductors 504 and 514. The inductor 520 operates as both the ZVS inductor and the transmitter element, e.g., 222 of transmitter 210, of the transmitter 500. In this way fewer components are required on the transmitter 500 allowing for the transmitter to be smaller and lighter. Additionally as additional capacitors and/or inductors are required to provide the transmitter element, as described in applicant's own US Patent Application Publication No 2021/0083634 A1, the contents of which are incorporated by reference, power transfer efficiency is improved.

The transmitter 500 has two unique switching frequencies in the overall circuit. The first switching frequency is that of the half-bridge to provide buck conversion. The second switching frequency is that of the Class E inverter. The first switching frequency will be much lower, in the order of tens of kHz, whereas the second switching frequency will be in the order of 100 khz to a few MHz.

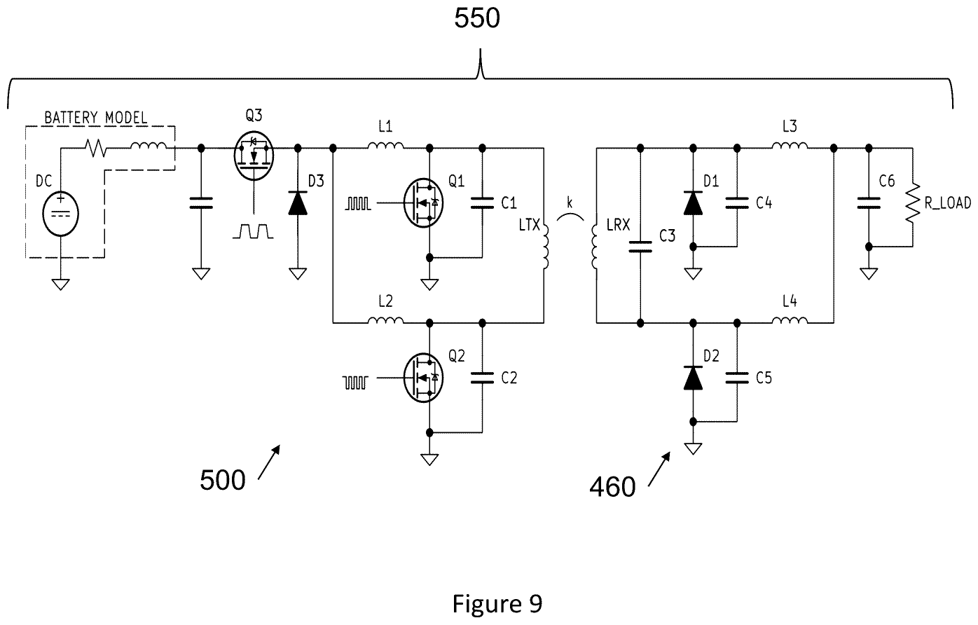

The transmitter 500 and receiver 460 are shown together forming wireless power transfer system 550 in FIG. 9. In operation, the transmitter 500 transfers power to the receiver 460 via magnetic coupling between inductor 520 of the transmitter 500 and inductor 462 of the receiver 460. The coupling coefficient between the transmitter 500 and receiver 460 is identified as k.

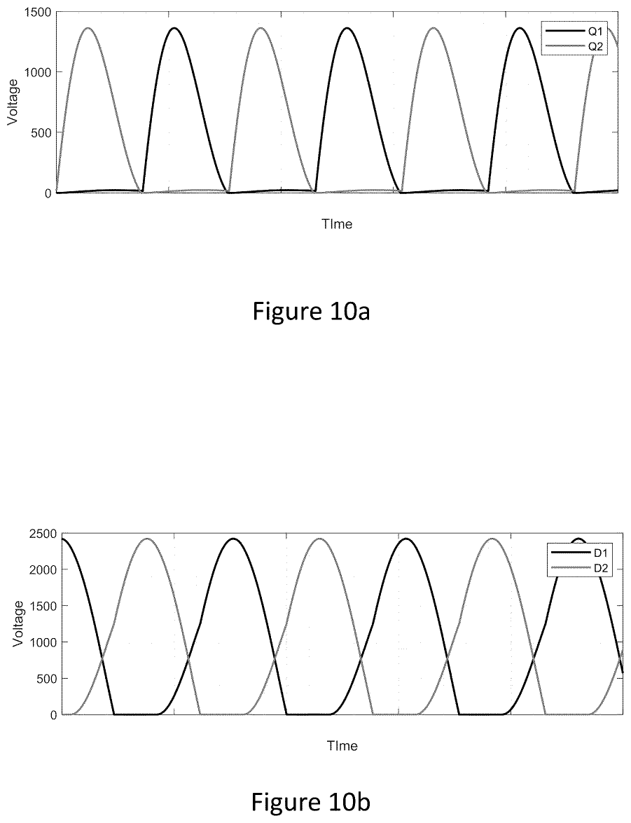

During operation, the voltages at transistors 506, 516 of the transmitter 500 are 180 degrees out of phase as illustrated in FIG. 10a. Similarly, the voltages at the diodes 470, 480 of the receiver 460 are out of phase as illustrated in FIG. 10b.

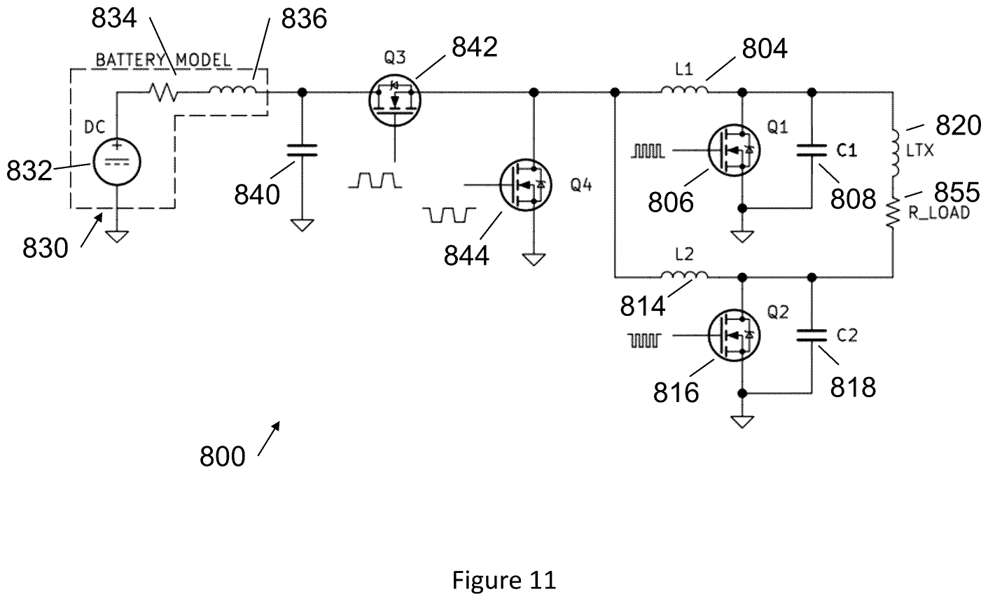

While particular transmitters have been described, one of skill in the art will appreciate that variations are possible. Turning now to FIG. 11, another arrangement of a transmitter is illustrated. In this arrangement, a transmitter 800 comprises the same elements as the transmitter 500 unless otherwise stated. Like elements are increased by “300”.

Rather than a diode 544 (D3) connected to the transistor 542 as in the transmitter 500, the transmitter 800 comprises a transistor 844 connected to the transistor 842. With this modification, the transmitter operates as a “synchronous buck” DC/DC converter. The transistor 844 operates in a complementary manner with the transistor 842.

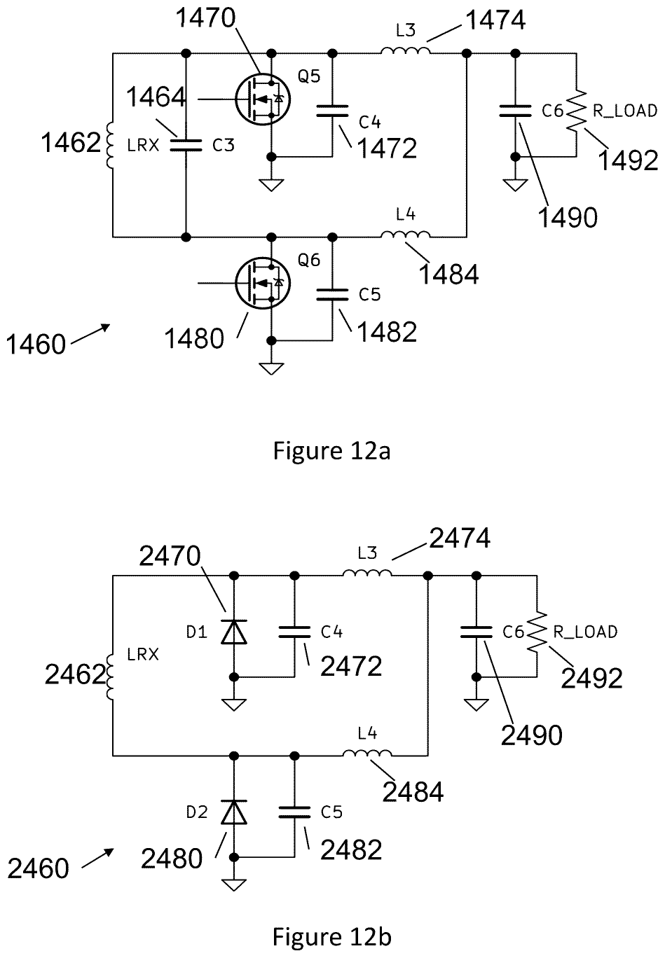

While particular receivers have been described, one of skill in the art will appreciate that variations are possible. Turning now to FIGS. 12a and 12b, other arrangements of a receiver are illustrated. In the arrangement illustrated in FIG. 12a, a receiver 1460 comprises the elements as the receiver 460 unless otherwise stated. Like elements are increased by “1000”. Specifically, the receiver 1460 comprises MOSFETs 1470, 1480 rather than diodes 470, 480. This may improve power transfer efficiency of the receiver 1460 when compared with the receiver 460, and/or a wireless power transfer system including the receiver 1460. Additionally or alternatively, replacing the diodes with MOSFETs may reduce losses, e.g., ohmic losses.

In the arrangement illustrated in FIG. 12b, a receiver 2460 comprises the elements as the receiver 460 unless otherwise stated. Like elements are increased by “2000”. Specifically, the receiver 2460 does not comprise is a capacitor which is connected in parallel to the inductor 1462, i.e., connected to the same two nodes. In this arrangement, the capacitor (i.e., capacitor 464 having a capacitor C3) is entirely omitted. This results in simpler receiver circuitry as the number of components required are reduced. Accordingly, the size (e.g., form/factor) of the receiver 2460 may be reduced. As such, the receiver 2460 may be suitable for applications for size constraints are paramount.

However, the receiver 2460 may lose its ability to provide a constant DC current across the entire load range. In other words, the receiver 2460 may provide a constant DC current output across a smaller range when compared with the receiver 460. For example, the receiver 2460 may only be suitable for a load resistance which varies approximately +−25% from its nominal value, whereas the receiver 460 may be suitable for a greater variation.

The capacitance C4, C5 of capacitors 2472, 2482 is given by equation 4 below:

C4,C5=α/ω²LRX Equation 4
ω is the operating frequency of the receiver 2460, α is a dimensionless factor such that 0.75<α<1.25, and LRX is the inductance of the receiver element. α is used to set the receiver 2460 to output a certain current value depending on the load resistance.

The described transmitter and receivers may be used in a variety of applications. For example, to power a rotor in an electric motor. Electric motors are used in a variety of applications including EVs. While electric motors may be permanent magnet synchronous motors, the use of rare-earth metals to provide the required permanent magnets may have negative environmental impacts and put a strain on the supply chain of such metals. As such, there is a move in the industry to replace permanent magnets with electromagnets in the rotor of an electric motor. The rotor now needs to be power externally. Such motors may be referred to as externally current-excited synchronous motors.

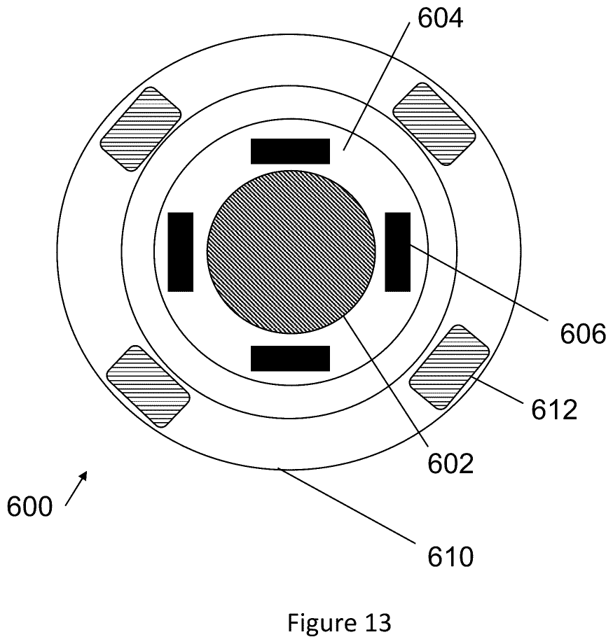

Turning to FIG. 13, an exemplary electric motor 600 is illustrated. The motor 600 comprises a stator 610 having windings 612 which form electromagnets. In the illustrated arrangement, four sets of windings 612 are present and these are equidistant within the stator 610. The stator 610 surrounds the rotor 604 which surrounds a central shaft 602. The rotor 604 comprises magnetic elements 606. As described, the magnetic elements 606 comprise permanent magnets in the case of permanent magnet synchronous motors. These permanent magnets may be replaced with electromagnets such that the motor 600 is an externally current-excited synchronous motor.

As the rotor 604 is rotating slip rings or brushes may be used to transfer current to the electromagnets. However, slip rings and brushes suffer from wear and tear, and therefore require regular maintenance and/or replacement. This increases costs and potential down-time of the motor 600. Alternatives are desired.

The described wireless power transfer system may be used in order to provide electrical power to the magnetic elements 606 of the stator 604. In an exemplary arrangement, the current required to the rotor is generally up to 20 A. The current must be regulated, controllable and adjustable. The rotor rotates at extremely high speeds, e.g., up to 20000 RPMs. The input voltage to the rotor may be 400V; however, it is expected to be up to 800V in the future. Therefore, a wireless power transfer system will have an input voltage 400V and then provide and output voltage of 400V. The transmitter of the system will be stationary, non-rotating, while the receiver will be rotating as it is associated with the rotor 604 and the magnetic elements 606.

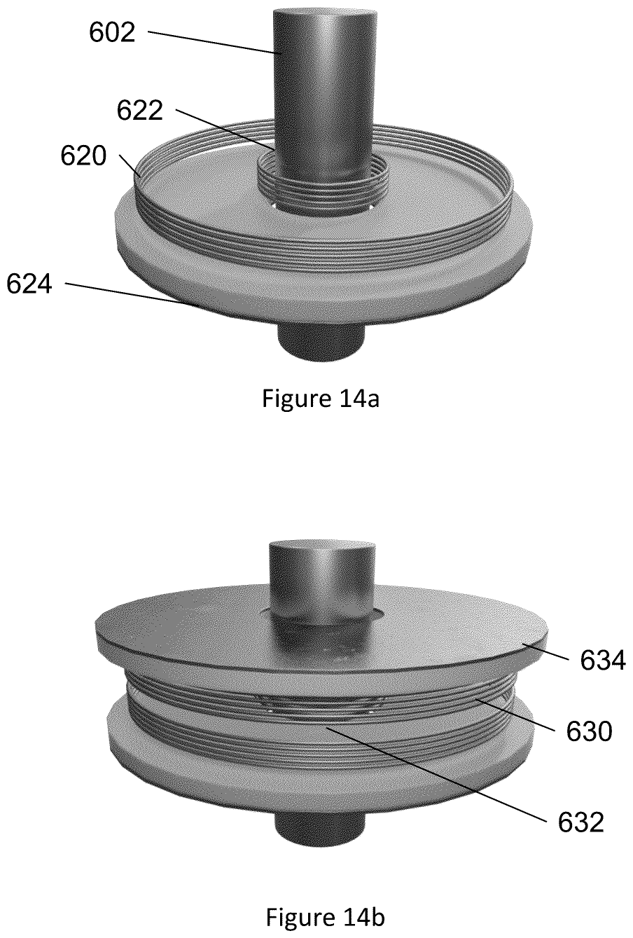

Turning now to FIG. 14a, a portion of a transmitter for use with such an electric motor 600 is illustrated. As shown, the transmitter comprises a transmitter element which in this arrangement takes the form a transmitter coil 620 comprising a plurality of overlaying windings which surround the shaft 602 of the motor 600. The windings are centred about the rotor 602 and are in the same axial plane. The windings generate a magnetic field to transfer power to a receiver as previously described.

The magnetic field may induce eddy currents in the shaft 602 resulting in losses. As such, the transmitter further comprises a field cancelling coil 622 comprises a plurality of windings which surround the shaft 602. The windings of the cancelling coil 622 are centred about the rotor 602 and are in the same axial plane. The windings of the cancelling coil 622 are parallel with the windings of the transmitter coil 620 in the radial plane of the shaft 602 of the motor 600. The field generated by the transmitter coil 620 is cancelled by the cancelling coil 622 which reduces losses from induced eddy currents.

The transmitter further comprises a shield which in this arrangement takes the form of a plate 624 which surrounds and is perpendicular to the shaft 602. The plate 624 protects the transmitter coil 620 and cancelling coil 622 from environmental influences.

Turning now to FIG. 14b, the transmitter is shown in combination with a receiver. Similar to the transmitter, the receiver comprises a receiver coil 630, field cancelling coil 632 and plate 634. These elements are oriented in the same manner as the elements of the transmitter. The receiver coil 630 is proximate the transmitter coil 620, as is the cancelling coil 632 of the receiver with respect to the cancelling coil 622 of the transmitter. The plate 634 of the receiver is opposite the transmitter coil 630 such that the transmitter and receiver coils 620, 630 and associated cancelling coils 622, 632 are surrounded by the plates 624, 634 in the axial plane defined by the shaft 602.

The transmitter is stationary and transfer power to the receiver which is rotating. During operation, power is transferred from the stationary transmitter coil 620 to the rotating receiver coil 630 to power the magnetic elements 606 of the stator 604.

A simulation was performed of the transmitter and receiver illustrated in FIG. 14b. In this simulation, the inductance of the transmitter coil 620 was found to be 4.2 uH with a Q-factor of 250 at an operating frequency of 1 MHz.

While cancelling coils 622, 632 are described, one of skill in the art will appreciate other configurations are possible. In another arrangement, the shaft 602 is wrapped in copper or aluminium around to provide a lower resistance loop for the induced eddy currents.

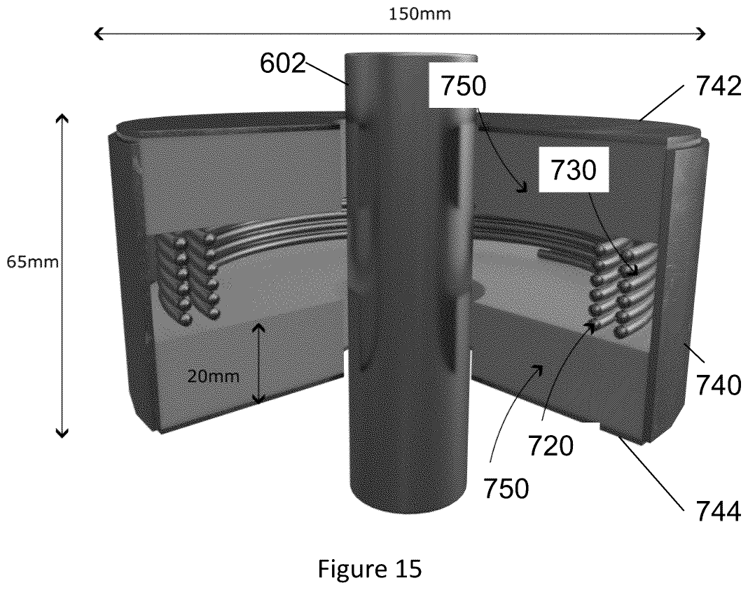

Turning now to FIG. 15, another arrangement of the transmitter and receiver coils is illustrated. In this arrangement, the transmitter coil 730 surrounds the receiver coil 720 which surrounds the shaft 602 of the motor 600. One of skill in the art will appreciate the transmitter coil 730 may instead be surrounding by the receiver coil 720. The coils 720, 720 are axially fixed in location, while allowing for rotation of the receiving coil 720 about the shaft 602 by separator material 750. The coils 720, 730 are enclosed by an enclosure defined by shielding plates 742, 744 and cylindrical shielding plate 740. The shielding enclosure shields the coils 720, 730 from environmental influences.

The arrangement of FIG. 15 was simulated with the following parameters. The height of the cylindrical shielding plate 740 was 65 mm, while the diameter of the circular shielding plates 742, 744 and shaft 602 totalled 150 mm. The separator material 750 was 20 mm thick on either axial side of the coils 720, 730. Under these conditions, the inductance of the transmitter coil 730 was 4.2 uH, while the inductance of the receiver coil 720 was 4.53 uH. The RF power transfer efficiency was found to be 97%.

During operation, power is transferred from the stationary transmitter coil 730 to the rotating receiver coil 720 to power the magnetic elements 606 of the stator 604.

Although embodiments have been described above with reference to the figures, those of skill in the art will appreciate that variations and modifications may be made without departing from the scope thereof as defined by the appended claims.

1. A transmitter for transferring power to a receiver of a wireless power transfer system, the transmitter comprising a transmitter element and an inverter comprising a switched mode zero-voltage switching (ZVS) amplifier comprising:
a pair of circuits comprising:
at least a transistor and at least a capacitor arranged in parallel; and
at least an inductor arranged in series with the transistor and capacitor;
a ZVS inductor electrically connected to the pair of circuits, the ZVS inductor operating as the transmitter element of the transmitter to transfer power to a receiver of a wireless power transfer system via magnetic field coupling.

2. The transmitter of claim 1, wherein the inverter comprises a combined direct current/direct current (DC/DC) converter and inverter for converting an input DC signal to a desired level and inverting a DC signal to alternating current (AC).

3. The transmitter of claim 2, wherein the combined DC/DC converter and inverter comprises a half-bridge and the inductors of the pair of circuits of the inverter, the inductors electrically connected to the half-bridge.

4. The transmitter of claim 3, wherein the half-bridge comprises a transistor and a diode electrically connected to the transistor in parallel.

5. The transmitter of claim 3, wherein the half-bridge has a first switching frequency, and the transistor of the pair of circuits has a second switching frequency.

6. The transmitter of claim 5, wherein the second switching frequency is larger than the first switching frequency.

7. The transmitter of claim 2, wherein the inductors are adapted to store and release energy for DC/DC conversion, and the inductors are adapted to operate as a choke for the inverter.

8. The transmitter of claim 2, wherein the inductors are adapted to provide a constant DC current.

9. The transmitter of claim 1, wherein the combined DC/DC converter and inverter is a class E inverter.

10. The transmitter of claim 1, wherein the combined DC/DC converter and inverter is load-independent.

11. A method of transferring power from a transmitter to a receiver of a wireless power transfer system, the transmitter comprising a transmitter element and an inverter comprising a switched mode zero-voltage switching (ZVS) amplifier comprising:
a pair of circuits comprising:
at least a transistor and at least a capacitor arranged in parallel; and
at least an inductor arranged in series with the transistor and capacitor;
a ZVS inductor electrically connected to the pair of circuits, the ZVS inductor operating as the transmitter element of the transmitter to transfer power to a receiver of a wireless power transfer system via magnetic field coupling, the method comprising:
generating a field via the transmitter element to transfer power to a receiver element of a receiver of a wireless power transfer system.

12. A receiver for extracting power from a field generated by a transmitter of a wireless power transfer system, the receiver comprising a receiver element electrically connected to a rectifier, the rectifier comprising a capacitor for converting a voltage signal at the receiver element to a current signal,
the capacitor electrically connected in parallel to the receiver element.

13. The receiver of claim 12, wherein the voltage signal is constant.

14. The receiver of claim 12, wherein the current signal is constant.

15. The receiver of claim 12, wherein the receiver comprises an impedance transformation circuit comprising the capacitor.

16. The receiver of claim 15, wherein the impedance transformation circuit has a T-network topology.

17. The receiver of claim 12, wherein a capacitance of the capacitor is:
$$C 3 = \frac{1}{{αω}^{2} ( LRX 2 + LRX 3 )}$$
where C3 is the capacitance of the capacitor,
α is a dimensionless factor such that 1.25<α≤3,
where ω is an operating frequency of the receiver,
where LRX2 is a portion of an inductance of the receiver element, and
wherein LRX3 is another portion of the inductance of the receiver element.

18. The receiver of claim 17, wherein the inductance of the receiver element is:
$$LRX = LRX 1 + LRX 2 + LRX 3$$
where LRX is the inductance of the receiver element.

19. The receiver of claim 12, wherein the rectifier comprises:
a pair of circuits comprising:
at least a diode and at least a capacitor arranged in parallel; and
at least an inductor arranged in series with the transistor and capacitor; and
the capacitor electrically connected to the pair of circuits and to the receiver element.

20. The receiver of claim 12, wherein the rectifier is a Class E rectifier or a push-pull rectifier.
